(19) United States
(12) Patent Application Publication
(10) Pub. No.: US 2011/0127860 A1
(43) Pub. Date: Jun. 2, 2011

(54) BRUSHLESS DC MOTOR

(76) Inventors: Dong Yeon SHIN, Gyunggi-do (KR); Jae Yoon Kim, Gyunggi-do (KR)

(21) Appl. No.: 12/773,759

(22) Filed: May 4, 2010

(30) Foreign Application Priority Data
Dec. 1, 2009 (KR) 10-2009-0117951

(51) Int. Cl. H02K 1/18

(52) U.S. Cl. 310/43

(57) ABSTRACT

A brushless DC motor. The motor includes a rotating shaft, a bearing rotatably supporting the rotating shaft in radial directions, a support holder made of a plastic material and supporting both the lower end of the rotating shaft and the outer circumferential surface of the bearing, a rotor casing having a rotor magnet therein and rotated along with the rotating shaft, a stator mounted to the outer circumferential surface of the support holder so as to face the rotor magnet and rotating the rotor casing by mutual cooperation with the rotor magnet in response to electricity applied from an external power source, and a plate, to which the support holder is locked using a locking screw. The brushless DC motor has a simple structure and reduces the material cost and assembly cost.

### CROSS REFERENCE TO RELATED APPLICATION(S)

This application claims the benefit of Korean Patent Application No. 10-2009-0117951, filed on Dec. 01, 2009, entitled “A Brushless DC Motor”, which is hereby incorporated by reference in its entirety into this application.

### BACKGROUND OF THE INVENTION

1. Technical Field

The present invention relates to a brushless DC motor.

2. Description of the Related Art

Generally, in a brushless DC motor for rotating an optical recording medium, such as an optical disc or a hard disc, lubrication oil forms an oil film between a bearing and a rotating shaft and rotatably supports the rotating shaft, thus realizing highly precise rotation performance of the rotating shaft, so that the brushless DC motor has been widely used as a drive motor for recording media drives requiring high speed rotation, such as hard disc drives and optical disc drives.

FIG. 1 is a sectional view of a part of a conventional brushless DC motor. Hereinbelow, the conventional brushless DC motor 10 will be described with reference to FIG. 1.

As shown in FIG. 1, the conventional brushless DC motor 10 comprises a rotating shaft 12, a support unit, a rotor casing 28, which is rotated along with the rotating shaft 12 and has a rotor magnet 30, and a stator 32, which is fabricated by winding a coil 32b around a core 32a producing an electric field upon receiving electricity from an external power source.

Here, the support unit supports the elements of the brushless DC motor, such as the rotating shaft 12. The support unit comprises a bearing unit and a bearing support for supporting the bearing unit. The bearing unit comprises a bearing 16, which supports the rotating shaft 12 in radial directions, and a thrust washer 18, which supports the rotating shaft 12 in an axial direction. The bearing support comprises a bearing holder 22 supporting the bearing 16, a washer holder 24 supporting the thrust washer 18, and a plate 26 supporting the bearing holder 22. Here, on the lower portion of the inner circumferential surface of the bearing holder 22, a stopper 20 is installed. The stopper 20 is inserted into a recess 14 of the rotating shaft 12 and prevents upward movement of the rotating shaft 12.

The bearing support is fabricated by using caulking or spinning to assemble the bearing holder 22 made of brass with the plate 26 and by assembling the washer holder 24 made of a steel plate with the bearing holder 22.

However, in the conventional brushless DC motor 10 having the above-mentioned construction and fabricated by the above-mentioned process, the bearing support comprises the bearing holder 22, the washer holder 24 and the plate 26, as described above, so that the motor 10 requires an additional assembling process requiring an additional assembling cost, thus increasing the production cost. Particularly, using caulking or spinning to assemble the bearing holder 22 with the plate 26 and to assemble the bearing holder 22 with the washer holder 24 results in plastic deformation of the elements, so that the quality of the products may be reduced. Further, when the quality of products is reduced by the plastic deformation of the elements, it is very difficult to disassemble and reassemble the elements, so that the elements must be discarded, thus requiring disposal cost.

Further, the bearing holder 22 is made of brass and the washer holder 24 and the plate 26 are made of steel plates, so that the holders and the plate increase the material cost and the cutting process cost, and run counter to the recent trends of lightness.

### SUMMARY OF THE INVENTION

The present invention is intended to provide a brushless DC motor, which has a simple construction and reduces both the material cost and the production cost.

The present invention is further intended to provide a brushless DC motor, which can realize lightness and increases the assembling strength, and in which the elements can be easily disassembled and reassembled when the elements are undesirably deformed and reduced in quality.

In one aspect of the present invention, there is provided a brushless DC motor comprising: a rotating shaft; a bearing rotatably supporting the rotating shaft in radial directions; a support holder made of a plastic material and supporting both a lower end of the rotating shaft and an outer circumferential surface of the bearing; a rotor casing having a rotor magnet therein and rotated along with the rotating shaft; a stator mounted to an outer circumferential surface of the support holder so as to face the rotor magnet and rotating the rotor casing by mutual cooperation with the rotor magnet in response to electricity applied from an external power source; and a plate, to which the support holder is locked using a locking screw.

Here, injection molding may be used to produce the support holder.

Further, the support holder may comprise: a circular plate part supporting the lower end of the rotating shaft; a cylindrical part extending upwards from the circular plate part and supporting the outer circumferential surface of the bearing; and a flange part radially extending from an outer circumferential surface of the cylindrical part and forming a seating surface for seating the stator thereon.

Further, the locking screw may be tightened to locking holes formed both in the plate and in the flange part.

Further, the locking screw may be tightened upwards from a lower surface of the plate.

Further, the lower end of the rotating shaft may be contact-supported by a thrust washer supported by the support holder.

Further, the lower end of the rotating shaft may be contact-supported by the support holder.

Further, the rotating shaft may be provided with a recess in a lower portion thereof so as to receive therein a stopper mounted to an inner circumferential surface of the support holder.

Further, the stopper may be integrated with the support holder.

Further, a drag magnet may be provided in an upper portion of the stator so as to prevent upward movement of the rotor casing.

Further, the locking screw may be tightened such that elements tightened by the screw include the stator.

Further, the locking screw may be tightened downwards from an upper surface of the stator.

Further, a drag magnet may be provided on a lower surface of the rotor casing facing the locking screw.

Further, the drag magnet may be provided on the lower surface of the rotor casing such that magnetic attraction is generated between the drag magnet and the locking screw.

### BRIEF DESCRIPTION OF THE DRAWINGS

FIG. 1 is a sectional view of a part of a conventional brushless DC motor;

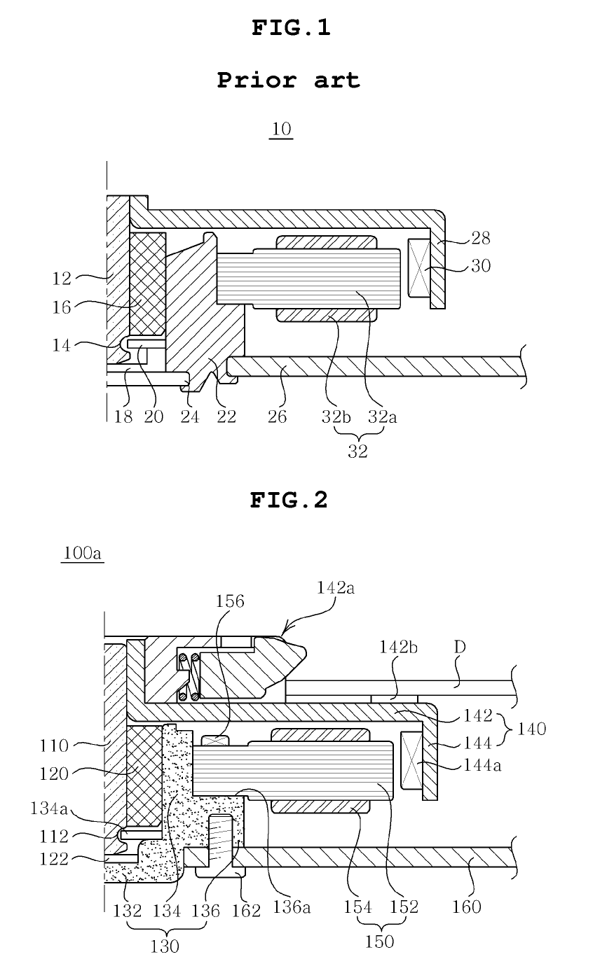

FIG. 2 is a sectional view of a part of a brushless DC motor according to a first embodiment of the present invention;

FIG. 3 is a sectional view of a part of a brushless DC motor according to a second embodiment of the present invention;

FIG. 4A and FIG. 4B are sectional views of parts of brushless DC motors according to a third embodiment of the present invention; and

FIG. 5 is a sectional view of a part of a brushless DC motor according to a fourth embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the terms to describe most appropriately the best method he or she knows for carrying out the invention.

The above and other objects, features and advantages of the present invention will be more clearly understood from the following detailed description taken in conjunction with the accompanying drawings. Herein, the same reference numerals are used throughout the different drawings to designate the same components. Further, when it is determined that the detailed description of the known art related to the present invention might obscure the gist of the present invention, the detailed description thereof will be omitted.

Hereinafter, the preferred embodiments of the present invention will be described in detail with reference to the accompanying drawings.

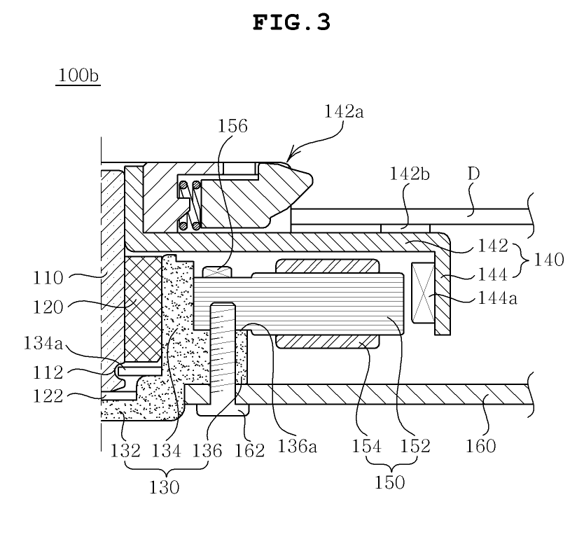

FIG. 2 is a sectional view of a part of a brushless DC motor according to a first embodiment of the present invention. Hereinbelow, the brushless DC motor 100a according to the first embodiment of the present invention will be described with reference to FIG. 2.

As shown in FIG. 2, the brushless DC motor 100a according to the first embodiment of the present invention comprises a rotating shaft 110, a bearing 120, a support holder 130, a rotor casing 140, a stator 150 and a plate 160.

The rotating shaft 110 has a cylindrical structure of a predetermined diameter and is rotated by an electromagnetic force generated by the correlation between a rotor magnet 144a and the stator 150. The rotating shaft 110 is rotated along with the rotor casing 140, which is securely mounted to the upper portion of the rotating shaft 110.

The bearing 120 supports the rotating shaft 110 in radial directions and has a hollow cylindrical structure having a shaft hole for receiving the rotating shaft 110 therein. The bearing 120 rotatably supports the rotating shaft 110 by lubrication oil charged between the bearing 120 and the rotating shaft 110.

The support holder 130 supports both the lower end of the rotating shaft 110 and the outer surface of the bearing 120 and has an integral structure made of a plastic material formed by injection molding. In other words, the support holder 130 has a structure in which a conventional bearing holder and a conventional support are integrated into a single structure. Because injection molding is used to integrally form the support holder 130 from a plastic material, it is possible to produce a support holder having a simple, light structure without executing an assembling process.

Here, the support holder 130 comprises a circular plate part 132 supporting the lower end of the rotating shaft 110, a cylindrical part 134 extending upwards from the edge of the circular plate part 132 and supporting the outer circumferential surface of the bearing 120, and a flange part 136 protruding outwards around the lower portion of the outer circumferential surface of the cylindrical part 134 and forming a seating surface 136a for seating the stator 150 thereon.

In the embodiment, a thrust washer 122 is seated on the upper surface of the circular plate part 132, the thrust washer supporting the lower end of the rotating shaft 110. The thrust washer 122 rotatably supports the rotating shaft 110 in the axial direction. However, it should be understood that, because the support holder 130 of the embodiment is made of a plastic material, the support holder 130 can rotatably support the rotating shaft 110 in the axial direction without using an additional thrust washer 122.

Further, a stopper 134a is mounted to the lower portion of the inner circumferential surface of the support holder 130 and is inserted into a recess 112 of the rotating shaft 110, and prevents upward movement of the rotating shaft 110. The flange part 136 is provided with a locking hole, to which a locking screw 162 is tightened, as will be described later herein.

The rotor casing 140 has a center hole and is fitted over the rotating shaft 110 such that the rotor casing 140 rotates along with the rotating shaft 110. For example, the rotor casing 140 may comprise a circular plate part 142, which is fitted over the rotating shaft 110 at a center hole thereof and extends outwards in radial directions from the rotating shaft 110, and an annular skirt part 144, which is bent downwards from the edge of the circular plate part 142 and has a rotor magnet 144a on the inner circumferential surface thereof. The rotor casing 140 having the above-mentioned structure may be produced through press-bending.

Here, the circular plate part 142 is provided on the central portion of the upper surface thereof with a chucking assembly 142a for chucking a loaded disk, and on a peripheral portion of the upper surface with a slip prevention member 142b for preventing slip of the loaded disc. Further, even though the accompanying drawings show that a disk D is loaded on the rotor casing 140, it should be understood that a disc turntable may be provided on the circular plate part 142 so as to load a disc thereon and the provision of the disc turntable does not depart from the scope and spirit of the present invention.

Further, the inner circumferential surface of the annular skirt part 144 is provided with a rotor magnet 144a so as to generate an electromagnetic force based on interaction between the rotor magnet 144a and the stator 150. Here, the interaction between the rotor magnet 144a and the stator 150 generates the force for rotating the rotor casing 140. Further, the rotor magnet 144a has an annular structure with alternating positive and negative magnetized regions arranged along the circumference of the annular magnet 144a.

The stator 150 generates an electric field in response to an electric current applied thereto from an external power source and comprises a core 152 and a coil 154 wound around the core 152. When an electric current is applied to the coil 154, the armature magnetic flux is excited based on the applied electric current and the excited armature magnetic flux interlinks with the magnetic flux generated by the rotor magnet 144a, thus producing torque and rotating the rotor casing 140.

Here, the stator 150 is securely seated on the outer circumferential surface of the support holder 130. In the present invention, it is better to securely seat the stator 150 on the seating surface 136a defined by the flange part 136.

Further, a drag magnet 156 may be provided on the upper surface of the core 152 so as to generate magnetic attraction in cooperation with the circular plate part 142 of the rotor casing 140, thus preventing upward movement of the rotor casing 140. Even though the accompanying drawings show that the drag magnet 156 is provided on the upper surface of the core 152, it should be understood that the drag magnet may be provided on the lower surface of the circular plate part 142 so as to generate magnetic attraction in cooperation with the stator 150, thus preventing upward movement of the rotor casing 140 without departing from the scope and spirit of the present invention.

The plate 160 supports the elements of the brushless DC motor and allows the brushless DC motor to be securely installed in a recording media drive, such as a hard disc drive, and is locked to the support holder 130 by the locking screw 162.

Here, the locking screw 162 is tightened to the plate 160 and the support holder 130, particularly, to the locking holes of both the plate 160 and the flange part 136 of the support holder 130, thus locking the support holder 130 and the plate 160 to each other. Here, the locking screw 162 is tightened upwards from the lower surface of the plate 160. Because the locking screw 162 can be easily assembled and disassembled, it is easy to disassemble and reassemble the elements when the elements become undesirably deformed and reduced in quality. Further, the use of the locking screw in the present invention solves the problem of a reduction in the strength of the assembly, which may be caused by the use of the support holder 130 made of a plastic material.

In the first embodiment, a circuit board (not shown), on which a variety of electric devices, such as an encoder, a connector and a passive element are mounted, is mounted to the upper surface of the plate 160.

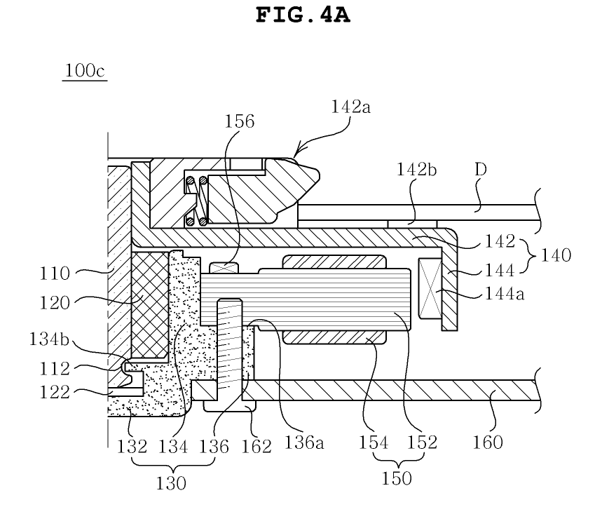

FIG. 3 is a sectional view of a part of a brushless DC motor according to a second embodiment of the present invention. Hereinbelow, the brushless DC motor 100b according to the second embodiment will be described with reference to FIG. 3. In the following description of the second embodiment, elements common both to the second and the first embodiments will carry the same reference numerals and duplicate descriptions will be omitted herefrom.

As shown in FIG. 3, the brushless DC motor 100b according to the second embodiment is characterized in that it has a structure in which the locking screw 162 is tightened to both the plate 160 and the support holder 130, particularly, to the locking holes formed in the plate 160, the flange part 136 of the support holder 130 and the stator 150, thus locking the plate 160, the support holder 130 and the stator 150 to each other. In other words, unlike the first embodiment, the second embodiment is characterized by the stator 150 being among the elements tightened by the locking screw 162. Because the second embodiment uses the above-mentioned structure, it is possible to omit a process of separately locking the stator 150 to the support holder 130 and to increase the tightening force of the elements by the locking screw 162.

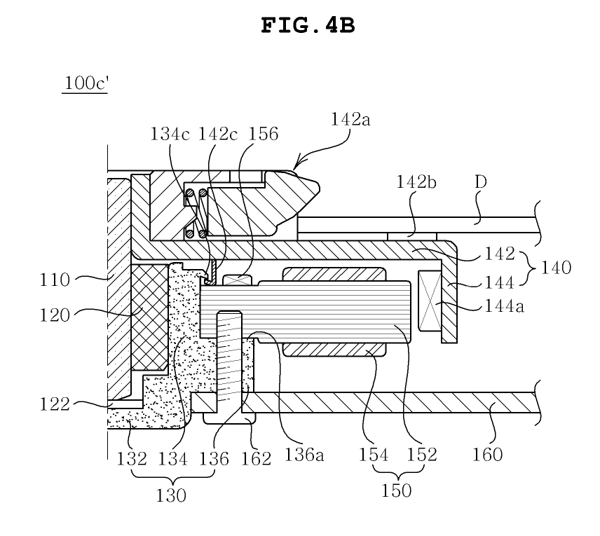

FIG. 4A and FIG. 4B are sectional views of parts of brushless DC motors according to a third embodiment of the present invention. Hereinbelow, the brushless DC motors 100c and 100c′ according to the third embodiment will be described with reference to FIGS. 4A and 4B.

As shown in FIG. 4A, the brushless DC motor 100c according to the third embodiment is characterized in that the stopper 134b described in the brushless DC motor 100a of the first embodiment is integrated with the support holder 130 into a single structure. In the third embodiment, injection molding using the same plastic material as that used in the support holder 130 is used to produce the stopper 134b. Because the construction of the brushless DC motor 100c remains the same as that described for the first embodiment except for the integration of the stopper 134b with the support holder 130, the elements, which are the same as or correspond to those of the first embodiment, will carry the same reference numerals as those of the first embodiment and further explanation is omitted.

As shown in FIG. 4B, the construction of the brushless DC motor 100c′ according to the third embodiment does not have a separate stopper, but a hooking protrusion 134c is integrally provided in the upper portion of the outer circumferential surface of the support holder 130 and a hook 142c is provided in the circular plate part 142 of the rotor casing 140 so as to be hooked to the hooking protrusion 134c, thus preventing upward movement of the rotor casing 140 when the rotor casing 140 rotates. In the third embodiment, the injection molding process used to produce the support holder 130 using a plastic material integrally forms the hooking protrusion 134c and the support holder 130.

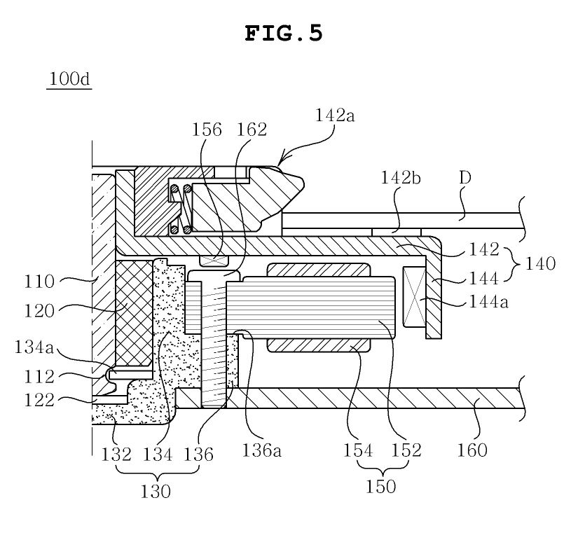

FIG. 5 is a sectional view of a part of a brushless DC motor according to a fourth embodiment of the present invention. Hereinbelow, the brushless DC motor 100d according to the fourth embodiment will be described with reference to FIG. 5. In the following description of the fourth embodiment, elements common to the fourth embodiment and to all of the first to third embodiments will carry the same reference numerals and duplicate descriptions will be omitted herefrom.

As shown in FIG. 5, the brushless DC motor 100d according to the fourth embodiment is characterized in that the locking screw 162 is tightened downwards while passing through the support holder 130 and the plate 160 from the upper surface of the stator 150. In the fourth embodiment, the drag magnet 156 is provided in the circular plate part 142 of the rotor casing 140 and is arranged such that magnetic attraction is generated between the locking screw 162 and the drag magnet 156.

As described above, the present invention provides a brushless DC motor. The brushless DC motor has a support holder formed by integration of a conventional bearing holder with a conventional washer holder, so that the motor has a simple structure, can be produced through a simple process, and reduces the production cost. Further, the support holder is made of a plastic material, so that the brushless DC motor realizes lightness and reduces the material cost.

Furthermore, in the brushless DC motor of the present invention, both the support holder and a stator are locked to a base plate using a locking screw, so that elements can be easily disassembled and reassembled when the elements are undesirably deformed and reduced in quality. Further, because the elements are locked to each other using the locking screw, the locking strength can be increased, thus solving the problem of a reduction in strength, which may be caused by the use of the support holder made of the plastic material.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Accordingly, such modifications, additions and substitutions should also be understood as falling within the scope of the present invention.

What is claimed is:

1. A brushless DC motor, comprising:
a rotating shaft;
a bearing rotatably supporting the rotating shaft in radial directions;
a support holder made of a plastic material and supporting both a lower end of the rotating shaft and an outer circumferential surface of the bearing;
a rotor casing having a rotor magnet therein and rotated along with the rotating shaft;
a stator mounted to an outer circumferential surface of the support holder so as to face the rotor magnet and rotating the rotor casing by mutual cooperation with the rotor magnet in response to electricity applied from an external power source; and
a plate, to which the support holder is locked using a locking screw.

2. The brushless DC motor as set forth in claim 1, wherein injection molding is used to produce the support holder.

3. The brushless DC motor as set forth in claim 1, wherein the support holder comprises:
a circular plate part supporting the lower end of the rotating shaft;
a cylindrical part extending upwards from the circular plate part and supporting the outer circumferential surface of the bearing; and
a flange part radially extending from an outer circumferential surface of the cylindrical part and forming a seating surface for seating the stator thereon.

4. The brushless DC motor as set forth in claim 3, wherein the locking screw is tightened to locking holes formed both in the plate and in the flange part.

5. The brushless DC motor as set forth in claim 1, wherein the locking screw is tightened upwards from a lower surface of the plate.

6. The brushless DC motor as set forth in claim 1, wherein the lower end of the rotating shaft is contact-supported by a thrust washer supported by the support holder.

7. The brushless DC motor as set forth in claim 1, wherein the lower end of the rotating shaft is contact-supported by the support holder.

8. The brushless DC motor as set forth in claim 1, wherein the rotating shaft is provided with a recess in a lower portion thereof so as to receive therein a stopper mounted to an inner circumferential surface of the support holder.

9. The brushless DC motor as set forth in claim 8, wherein the stopper is integrated with the support holder.

10. The brushless DC motor as set forth in claim 1, wherein a drag magnet is provided in an upper portion of the stator so as to prevent upward movement of the rotor casing.

11. The brushless DC motor as set forth in claim 1, wherein the locking screw is tightened such that the stator is among elements tightened by the screw.

12. The brushless DC motor as set forth in claim 11, wherein the locking screw is tightened downwards from an upper surface of the stator.

13. The brushless DC motor as set forth in claim 12, wherein a drag magnet is provided on a lower surface of the rotor casing facing the locking screw.

14. The brushless DC motor as set forth in claim 13, wherein the drag magnet is provided on the lower surface of the rotor casing such that magnetic attraction is generated between the drag magnet and the locking screw.
